(19) United States
(12) Patent Application Publication
(10) Pub. No.: US 2006/0236343 A1
(43) Pub. Date: Oct. 19, 2006

(54) System and method of locating and providing video content via an IPTV network

(75) Inventor: Hisao M. Chang, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, LP, Reno, NV (US)

(21) Appl. No.: 11/106,361

(22) Filed: Apr. 14, 2005

(51) Int. Cl. G06F 13/00; G10L 11/06; H04N 5/445

(52) U.S. Cl. 725/61; 725/52; 725/53; 704/214; 704/235

(57) ABSTRACT

A method of obtaining video content is disclosed and includes receiving a spoken search, determining each word in the spoken search in a word-sensitive context, generating a first plurality of hypothetical search strings, and searching a text-based video content library index with the first plurality of hypothetical search strings. Further, the method includes determining whether any video content titles within the text-based video content library index match each of the first plurality of hypothetical search strings and transmitting a first plurality of matching video content titles to an intelligent media center.

### FIELD OF THE DISCLOSURE

The present disclosure relates to Internet protocol television services.

### BACKGROUND

Current television (TV) cable and satellite systems are limited to a few hundred channels. Further, the primary user interface that is typically used for channel surfing is a hand-held TV remote control having twenty (20) to thirty (30) push buttons. More recently, TV-centric digital media center (DMC) systems have been provided and include a wireless keyboard similar to a personal computer (PC) keyboard that allows TV viewers to surf channels and control the DMC.

In an Internet-enabled broadband content access paradigm, such as an Internet Protocol based TV (IPTV) service, there may be hundreds of thousands or even millions of video content titles available over an IPTV service provider broadband network. With such a large number of available titles, it may be difficult for a user to locate a particular video content title—especially while using a traditional TV remote control device.

Accordingly, there is a need an improved system and method of locating and providing video content within an IPTV network.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of a representative IPTV system;

FIG. 2 is a diagram representative of a graphical user interface that can be presented at an IPTV;

FIG. 3 is a flow chart to illustrate a method of receiving a spoken search or a spoken clarification;

FIG. 4 is a flow chart to illustrate a method of receiving video content at an intelligent media center (IMC); and

FIG. 5 is a flow chart to illustrate a method of locating video content.

### DETAILED DESCRIPTION OF THE DRAWINGS

A method of obtaining video content is disclosed and includes receiving a spoken search, determining each word in the spoken search in a word-sensitive context, generating a first plurality of hypothetical search strings, and searching a text-based video content library index with the first plurality of hypothetical search strings. Further, the method includes determining whether any video content titles within the text-based video content library index match each of the first plurality of hypothetical search strings and transmitting a first plurality of matching video content titles to an intelligent media center.

In a particular embodiment, the method includes indicating to the intelligent media center that no matching video content titles exist. Also, in a particular embodiment, the method includes generating a word graph in real-time from the spoken search and transmitting the word graph to the intelligent media center. In yet another particular embodiment, the method includes generating a list of matching video content titles corresponding to the first plurality of matching video content titles. The list of matching video content titles includes each of the first plurality of matching video content titles, a rating of each of the first plurality of matching video content titles, a viewing duration of each of the first plurality of matching video content titles, and a summary description of each of the first plurality of matching video content titles. Further, the summary description of each of the first plurality of matching video content titles includes at least one matching word from the spoken search and at least two words surrounding the matching word.

In another particular embodiment, the method also includes receiving a spoken clarification associated with the spoken search, concatenating the spoken clarification with the spoken search, generating a second plurality of hypothetical search strings based on the spoken search and the spoken clarification, searching the text-based video content library index with the second plurality of hypothetical search strings, determining whether any video content titles within the text-based video content library index match the second plurality of hypothetical search strings, and transmitting a second plurality of matching video content titles to the intelligent media center.

In still another particular embodiment, the method includes determining a storage category for each of the first plurality of matching video content titles, determining a dominant storage category for the first plurality of matching video content titles, and transmitting a video advertisement to the intelligent media center. In a particular embodiment, the dominant storage category is a storage category that is determined to be associated with most of the first plurality of matching video content titles. Moreover, the video advertisement is associated with the dominant storage category. Additionally, the video advertisement is further associated with an advertising customer that has submitted a highest advertising bid for the dominant storage category.

In another embodiment, a method of obtaining video content is disclosed and includes receiving a spoken search from a wireless access terminal, transmitting the spoken search to a server over a network, receiving a plurality of matching video content titles from the server, and comparing the plurality of matching video content titles to a locally stored search history.

In still another embodiment, a system is disclosed and includes a video content library database that stores a plurality of video content titles. Further, the system includes a video content library index that includes a text title that is associated with each of the plurality of video content titles stored within the video content library database and includes a text description of each of the plurality of video content titles. In this embodiment, the system includes a server that is coupled to the video content library database and that is coupled to the video content library index. The server includes a processor, a computer readable medium accessible to the processor, and a computer program embedded within the computer readable medium. In this embodiment, the computer program includes instructions to receive a spoken search, instructions to generate a first plurality of search strings from the spoken search, and instructions to search the video content library index based on the first plurality of search strings in order to locate one or more matching video content titles.

In yet another embodiment, a portable electronic device is disclosed and includes a microphone, a talk button, a processor, and a computer readable medium that is accessible to the processor. Further, a computer program is embedded within the computer readable medium. The computer program includes a speech input agent and a distributed speech recognition front-end. In this embodiment, the speech input agent can be activated in response to a selection of the talk button. Moreover, the speech input agent can use the distributed speech recognition front-end in order to record speech input that is received by the microphone in a high fidelity mode.

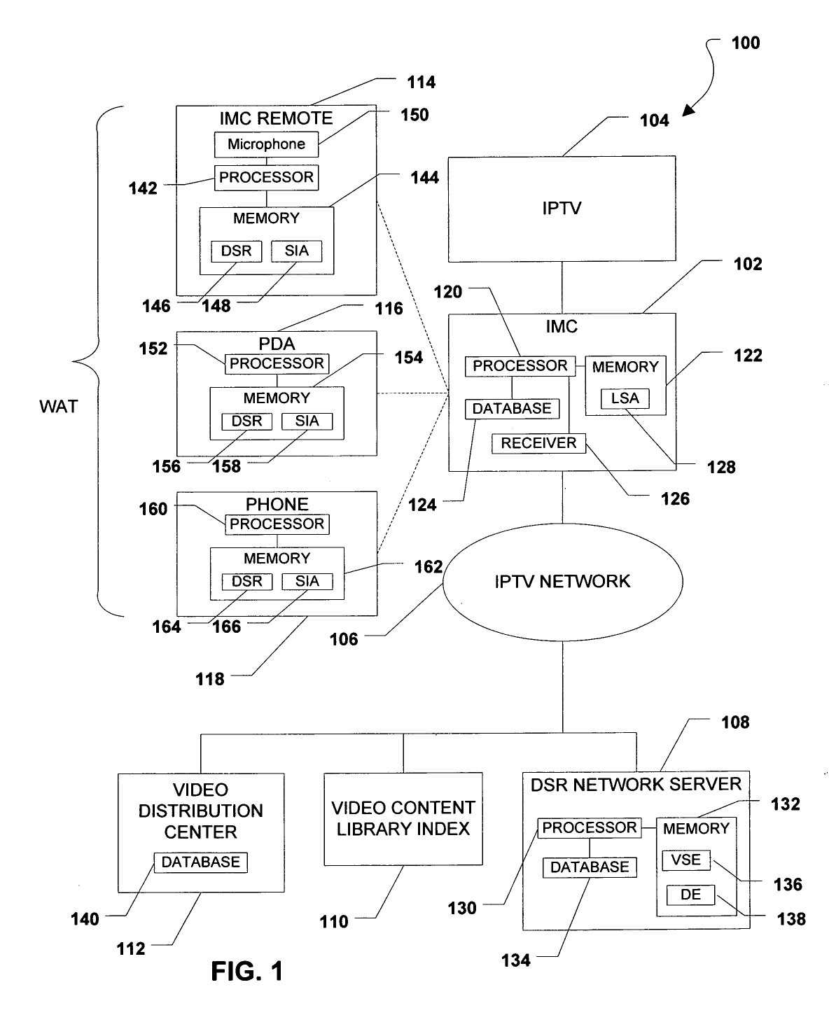

Referring to FIG. 1, a particular embodiment of an Internet protocol television (IPTV) system is shown and is generally designated 100. As shown, the IPTV system 100 includes an intelligent media center (IMC) 102 that is coupled to an IPTV device 104. FIG. 1 further indicates that the IMC 102 is coupled to an IPTV network 106, which, in turn, is coupled to a distributed speech recognition (DSR) network server 108, a video content library index 110, and a video distribution center 112.

In a particular embodiment, one or more wireless access terminals (WATs) can be wirelessly coupled to the IMC 102. For example, as depicted in FIG. 1, an IMC remote 114 can be wirelessly coupled to the IMC 102, a PDA 116 can be wirelessly coupled to the IMC 102, and a telephone 118 can be wirelessly coupled to the IMC 102. In a particular embodiment, the IMC remote 114 can include a built-in microphone. Further, in a particular embodiment, the telephone 118 can be a dual-mode 3G mobile phone that supports Wi-Fi capability.

In an exemplary, non-limiting embodiment, as illustrated in FIG. 1, the IMC 102 can include a processor 120 and a memory 122 coupled thereto. In a particular embodiment, the memory 122 can include a computer program that is embedded therein and that can include logic instructions to perform one or more of the method steps described herein. A local search history database 124 can also be coupled to the processor 120. In a particular embodiment, the local search history database 124 stores the search history associated with one or more local users of the IMC 102. FIG. 1 further shows that the IMC 102 can include a local search agent 128 that can be embedded within the memory 122.

In an illustrative embodiment, as shown in FIG. 1, the DSR network server 108 can include a processor 130 and a memory 132 that is coupled to the processor 130. In a particular embodiment, the memory 132 can include a computer program that is embedded therein that can include logic instructions to perform one or more of the method steps described herein. Additionally, a word N-tuple probability database 134 can be coupled to the processor 130. FIG. 1 also shows that a video search engine (VSE) 136 and a dictation engine (DE) 138 can be embedded within the memory 132 of the DSR network server 108. As illustrated in FIG. 1, the video distribution center 112 can include a video content library database 140 that stores a range of different types of video content. For example, the video content library database 140 can include movies, video games, television shows, sporting events, news events, etc.

In an exemplary non-limiting embodiment, the IMC remote 114 includes a processor 142 and a memory 144 that is coupled to the processor 142. In a particular embodiment, the memory 144 can include one or more computer programs that are embedded therein and that can include logic instructions to perform one or more of the method steps described herein. Further, a distributed speech recognition (DSR) front-end 146 and a speech input agent (SIA) 148 can be embedded within the memory 144 of the IMC remote 114 and can include logic instructions to perform one or more of the method steps described herein.

FIG. 1 further indicates that the IMC remote 114 can include a built-in microphone 150 that can be used to capture a spoken search request from a user. Also, the PDA 116 includes a processor 152 and a memory 154 that is coupled to the processor 152. In a particular embodiment, the memory 154 can include one or more computer programs that are embedded therein that include logic instructions to perform one or more of the method steps described herein. As shown, in an illustrative embodiment, a DSR front-end 156 and an SIA 158 are embedded within the memory 154 of the PDA 116 and can include logic instructions to perform one or more of the method steps described herein.

As depicted in FIG. 1, the telephone 118 can include a processor 160 and a memory 162 that is coupled to the processor 160. In a particular embodiment, the memory 162 can include one or more computer programs that are embedded therein and that can include logic instructions to perform one or more of the method steps described herein. As shown, A DSR front-end 164 and an SIA 166 can be embedded within the memory 162 of the telephone 118 and can include logic instructions to perform one or more of the method steps described herein.

In a particular embodiment, the IPTV system 100 can be used to locate video content. For example, in order to search for a video title from the vast video content library database via the IPTV network 106, a user can activate an SIA on a WAT, such as the SIA 148 on the IMC remote 114, by pushing a “talk” button and then, speaking a search phrase such as “Last week's Apprentice” or “I want to watch that Peter Jennings interview with Bill Gates last Friday.” As such, a keyboard is not required to input a spoken content search to the IPTV network 106. In a particular embodiment, the SIA on each WAT uses a DSR front-end to record speech input in a high fidelity mode in order to reduce the loss of acoustic information related to speech recognition. After a DSR front-end extracts select acoustic/phonetic features from the recorded speech, the DSR front-end sends highly compressed speech in real-time to the DSR network server 108 as a series of data packets. In a particular embodiment, the LSA within the IMC passes the compressed speech received from the WAT to the DSR network server 108 via the IPTV network 106.

In an illustrative embodiment, on the network side of the IPTV system 100, the VSE 136 within the DSR network server 108 uses the speaker-independent DE 138 that accepts unconstrained natural speech specifiable with a set of context-sensitive grammars (CSG). The DE 138 can recognize each word in a spoken search in a word-sensitive context. This can significantly reduce the total number of possible word candidates for a given context. For example, in a context of “movie titles”, the word pair “Harry Potter” is probably much more likely to appear in a search string than another word-pair “Harry Chang.”

In a particular embodiment, as each new word in a spoken search is recognized by the DE 138, the DE 138 can further refine the context in which the words currently recognized are linked together in order to add more specificity to the intended meaning of the spoken search. The DE 138 can generate one or more hypothetical search strings that can be used to search a text-based video content library index 110. In a particular embodiment, the first 100 matching titles, e.g., the text associated with the first 100 matching titles, can be retrieved from the video content library index 110 by the DSR network server 108. The DSR network server 108 can send the first 100 matching titles over the IPTV network 108 to the LSA 128 within the IMC 102. The LSA 128 can compare the search results from the VSE 136 to the local search history stored at the IMC 102, select the first 5 to 8 most likely titles, and display those most likely titles at the IPTV device 104 for the user to select.

In a particular embodiment, the DSR front end at each WAT is capable of recording speech in a high fidelity mode, such as by encoding speech at 16 bits per sample and 16,000 samples per second. This can produce a total bit rate at 256 Kbits. As speech input is recorded, each DSR front-end can extract a set of speech features that are valuable to a DE 138 that uses a MEL Cepstrum analysis. As a result, each frame of the original high-fidelity speech that is recorded every ten milliseconds (10 msec) can be represented by as few as eight (8) Mel-Frequency Cepstral Coefficients (MFCC). With the inclusion of other features, such as pitch and signal energy, the original high-fidelity speech can be encoded with as few as eleven (11) features. This coding can effectively reduce the bit rate from 256 Kbits for the original high-fidelity speech input to as low as 17.6 Kbits (11 features with 16 bits per feature extracted every 10 msec, which equates to a bit rate=11×16×100). As such, the bandwidth for the uplink over the IPTV network 106 can be reduced by a factor of approximately 14.

Also, in a particular embodiment, the video content library index 110 includes a text-based entry for every video title that is available to IPTV subscribers. Each index entry contains a number of text fields in which text content may be copied directly from the media source provided by the content provider or assigned by an IPTV service provider. Table 1 depicts an exemplary, non-limiting embodiment of a record format for the video content library index 110.

TABLE 1
An Exemplary, Non-Limiting Record Format
for Video Content Index Library

| | Title | Content | Sponsors' | |
|---|---|---|---|---|
| Title No. | Description | Description | Ads | VR |
| . . . | . . . | . . . | | |
| 541703032 | Harry Potter | Relive the magic | 324240409 | 5 |
| | and the | for the third time! | 359482340 | |
| | Prisoner of | Join Harry and his | | |
| | Azkaban | friends for another | | |
| | | year of adventure at | | |
| | | Hogwarts. Duration: | | |
| | | 2:22 Rating: PG | | |
| | | Category: Movie | | |

As shown in Table 1, each record in the video content index library 110 can include a title number, a title description, a partial or whole content description, a listing of advertisements that can be broadcast with a search that includes the particular title, and a Value Rating (VR) number, described below.

Further, in an exemplary, non-limiting embodiment, the DE 138 can be automatically tuned, e.g., daily, using the textual information stored in the video content library index. The frequencies of word N-Tuples, e.g., single word unit (N=1), word-pairs (N=2), tri-word phrases (N=3), etc., plus people or character names can be computed from the library index off-line. The result can be stored in the Word N-tuple probability database 134. The Word N-tuple probability database 134 can be used by the DE 138 to generate word-level probabilities for a spoken search that is uploaded from the IMC 102.

In addition to the static text data stored in the library index, which is derived from the original video content library database 140, an IPTV service provider can assign a Value Rating (VR) number, such as 1 to 5 with 5 representing Five Star for a most popular video title, based on market demand, seasonality, and other service-specific value. In a particular embodiment, the VR numbers can be assigned daily. If the words recognized in a spoken search match two video titles with an identical matching score, the one with the higher VR number will be put on the top of the list to be sent back to the IMC 102. Also, based on the value of a video advertisement, e.g., the amount of the money the an advertising customer is willing to pay to have their advertisement transmitted with a given title, an entry in the index library may also contain one or more video advertisements. If the sponsored entry appears at the top of a search list and is guaranteed to be seen by the IPTV viewers, these video advertisements associated with the sponsor will be automatically downloaded to the IMC 102 and broadcast at the IPTV device 104.

In a particular embodiment, the DE 138 can generate a word graph in real-time so that a partial recognition result can be used to guide the search via a display window managed by LSA 128 at the IMC 102. For example, while a user is speaking a search request, the DE 138 can start to construct a word graph for each new word heard using a word N-tuple probability database as depicted in Table 2.

TABLE 2
An Exemplary, Non-Limiting Word N-Tuple Database.

| Word #1 | | | Word #2 | | | Word #n | |
|---|---|---|---|---|---|---|---|
| Words | C# | | Words | C# | | Words | C# |
| Harry | 95% | → | Potter | 95% | → | . . . | — |
| Larry | 92% | | Porter | 95% | | . . . | — |
| Terry | 90% | | Tutor | 90% | | . . . | — |
| Perry | 85% | | Perry | 85% | | . . . | — |
| Prairie | 75% | | Prairie | 75% | | . . . | — |
| . . . | 65% | | . . . | 65% | | . . . | — |

In a particular embodiment, words, word-pairs, or triple-word blocks can be assigned a confidence number (C#). As such, words, word-pairs, or triple-word blocks having relatively low C#s may be held back and not used to immediately search the video content library index. For the very first word recognized with a high confidence, there may be thousands of matching titles in the video content library index. However, as each new spoken word is received and recognized with a high confidence, the list of the matching titles will be modified by removing those titles that do not contain the new word and by adding the new titles that contain all the words recognized.

In a particular embodiment, due to limited screen space at the IPTV device 104, it is not feasible to include every single word in a matching title in the list. As such, in an illustrative embodiment, the VSE 136 can construct a search list of the matching titles using a special word filter. The word filter can be constructed using the words that are recognized from the spoken search. Further, the VSE 136 can apply this filter to the content description for each matching title and select a group of the words near the words in the filter. For example, if the word “third” is in the filter, the first sentence, e.g., “Relive the magic for the third time!”, in a matching title as listed in Table 2 will be selected and provided to the IMC 102. In order to provide a visual confirmation for the words heard, matching words in a content description field can be tagged so that the IMC 102 will display it in a special color or bold face at the IPTV device 104.

Also, in a particular embodiment, the VSE 136 can provide a paid word meter for high-value content titles. For example, certain video content titles, e.g., a new video game, may have a much higher pay-per-view dollar value than others, e.g., an older movie. Using a paid word meter, the entire text block for a content description field may be included for the high-value content title instead of just a single sentence.

Additionally, in a particular embodiment, the VSE 136 can maintain a dialog context when a spoken clarification is received in order to clarify a spoken search. In such a case that a first spoken search does not result in the title that the user is looking for, the user may transmit a spoken clarification to provide additional information about the video content that the user desires. For example, if a user wants to see a “movie about the Alamo,” but the results received are too broad, he or she can simply add to the original spoken search request by speaking “played by John Wayne.”

Since the VSE 136 maintains a dialog context, the VSE 136 knows that the spoken clarification should be interpreted in the context of the original spoken search. As a result, the VSE 136 can concatenate the words recognized in the spoken search and the spoken clarification to form a new search string. The resulting search string can be used to search the video content library index 110. Accordingly, concatenating the spoken clarification with the spoken search can significantly reduce the size of the return list of the matching titles.

Further, in a particular embodiment, the VSE 136 provides a mechanism for a providing content-related video advertisements that can be broadcast at the IPTV device 104 while the user is in a search mode. In order to increase the effectiveness of the video advertisements, an IPTV service provider can offer advertising customers an option to index their video advertisements using key words, e.g., sports, action movies, video games, etc. As such, when numerous entries in a search list generated by the DE 138 share a common theme, such as video games, then one or more video advertisements for a high advertising bidder for the video games category will be transmitted to the IMC 102 and broadcast at the IPTV device 104. Accordingly, video advertisements transmitted with the search results are highly relevant to the spoken search received from the user and have a higher probability of being viewed by the user.

In a particular embodiment, the LSA 128, described above, maintains a local search history within the local search history database 124 for each user. Each local search history contains one or more successful search entries selected by the user in the past N days. N can be configured by each user of the IMC 102. In a particular embodiment, a search entry can be considered successful if the entry was selected by a user from the search list returned from the VSE 136. Since the successful entries in a search history contain those words that were highlighted in a special color or bold face that were correctly recognized and implicitly confirmed by the user in prior IPTV search sessions, the LSA 128 uses those entries to further constrain a long search list returned from the VSE 136.

For example, if a spoken search triggers a long search list, e.g., 85 matching titles, the IMC 102 may require as many as 10 screens to display a list from which the user may select a title. Using a locally cached search history, the LSA 128 can re-arrange the order of the display for the entries in the search list. For example, if a particular entry in the resulting list contains words that have a high hit rate to the local search history, e.g., a word that has been spoken by the same user and has been correctly recognized by the system during prior search sessions, that particular entry can have a higher probability for being correct for a current search.

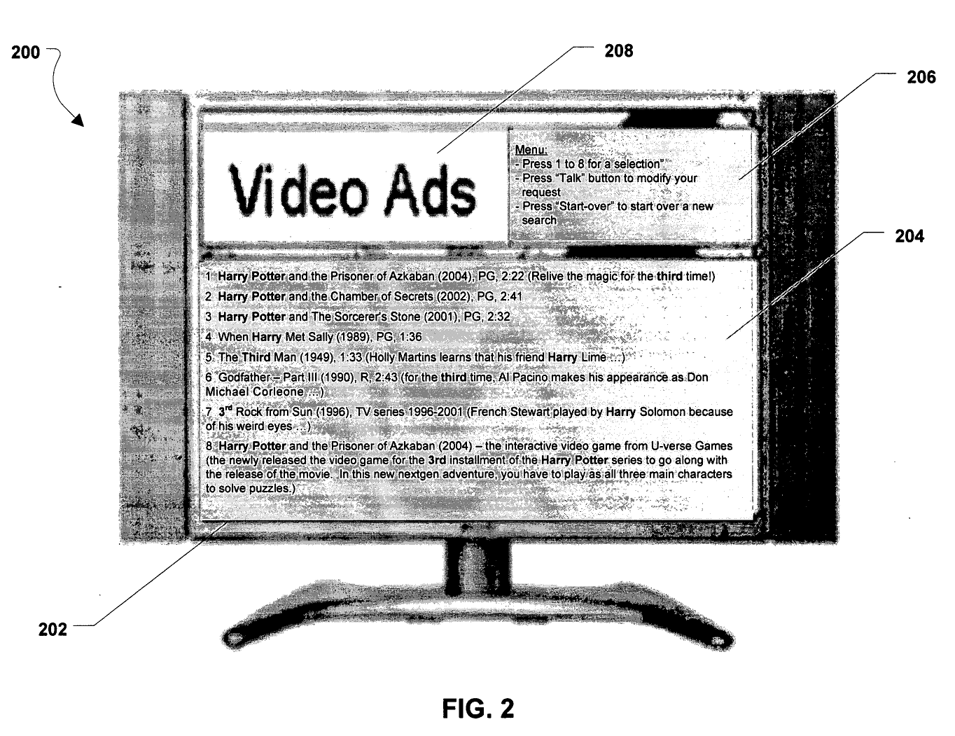

FIG. 2 illustrates an exemplary, non-limiting embodiment of an Internet protocol television (IPTV) 200 that can be used in conjunction with an IPTV system, e.g., the IPTV system 100 shown and described herein. As shown in FIG. 2, the IPTV 200 includes a graphical user interface (GUI) 202 that a user can use to search for content available via an IPTV network. The GUI 202 includes a menu of most likely matching video content titles 204, a menu of commands 206, and a video advertisement broadcast window 208.

In an illustrative embodiment, the menu of most likely matching video content titles 204 is generated in response to the results of a spoken search. As shown, the menu of most likely matching video content titles includes a list of video content titles, a release date for each video content title on the list, and a rating for each video content title on the list. In a particular embodiment, the menu of most likely matching video content titles 204 can also include a portion of a description for each of the video content titles on the list. Also, the menu of commands 206 can include one or more commands for a user to use in conjunction with the GUI 202.

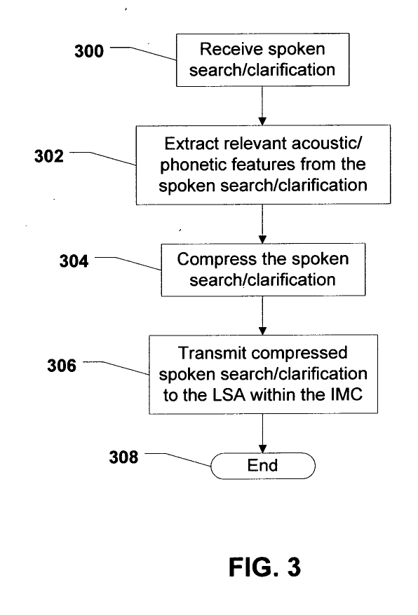

Referring to FIG. 3, a method of receiving a spoken search is shown and commences at block 300. At block 300, a WAT receives a spoken search or a spoke clarification. At block 302, the DSR within the WAT extracts the relevant acoustic/phonetic features from the spoken search or spoken clarification. Moving to block 304, the DSR within the WAT compresses the spoken search or spoken clarification. Next, at block 306, the WAT transmits the compressed spoken search or compressed spoken clarification to the IMC, e.g., to a local service agent (LSA) within the IMC. The method then ends at state 308.

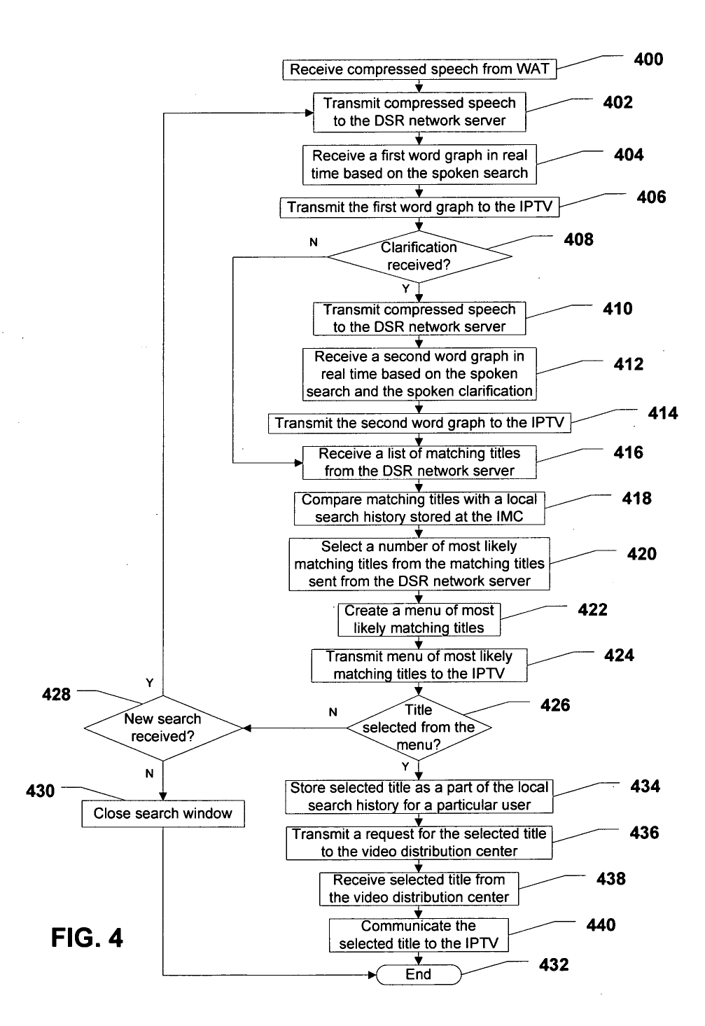

FIG. 4 illustrates a method of receiving video content at an intelligent media center (IMC). Beginning at block 400, the IMC receives compressed speech from a WAT that is wirelessly linked to the IMC. In a particular embodiment, a local service agent (LSA) within the IMC receives the compressed speech from the WAT. At block 402, the IMC transmits the compressed speech to a server, e.g., the DSR network server described above. Moving to the block 404, the IMC receives a first word graph in real-time based on the spoken search. At block 406, the IMC transmits the first word graph to the IPTV.

Proceeding to decision step 408, the IMC determines whether a spoken clarification has been received from the WAT. If so, the method moves to block 410, and the IMC transmits compressed speech, that includes the spoken clarification, to the DSR network server. At block 412, the IMC receives a second word graph in real-time. In a particular embodiment, the second word graph is based on the spoken search and the spoken clarification. Next, at block 414, the IMC transmits the second word graph to the IPTV.

Continuing to block 416, the IMC receives a list of matching titles from the DSR network server. Returning to decision step 408, if a spoken clarification is not received, the method jumps directly to block 418. At block 418, the IMC compares the list of matching titles to a local search history stored at the IMC. In an illustrative embodiment, the local search history is stored within a local search history database within the IMC. Proceeding to block 420, the IMC selects a number of most likely matching titles from the matching titles that are sent from the DSR network server. Thereafter, at block 422, the IMC creates a menu of most likely matching titles. At block 424, the IMC transmits the menu of most likely matching titles to the IPTV. In a particular embodiment, the menu includes a list of the most likely matching titles, a rating for each title on the list, and a viewing duration. Further, the menu can include a partial description of one or more of the titles on the list.

Moving to decision step 426, the IMC determines whether a title is selected from the menu. If not, the method moves to decision step 428 and the IMC determines whether a new search is received. If so, the method returns to block 402 and continues as described herein. Otherwise, the method continues to block 430 and the IMC closes the search window. The method then ends at state 432.

Returning to decision step 426, if a title is selected from the menu, the method proceeds to block 434 and the IMC stores the selected title as a part of the local search history for a particular user. Next, at block 436, the IMC transmits a request for the selected title to the video distribution center. Moving to block 438, the IMC receives the selected title from the video distribution center. Thereafter, at block 440, the IMC communicates the selected title to the IPTV. The method then ends at state 432.

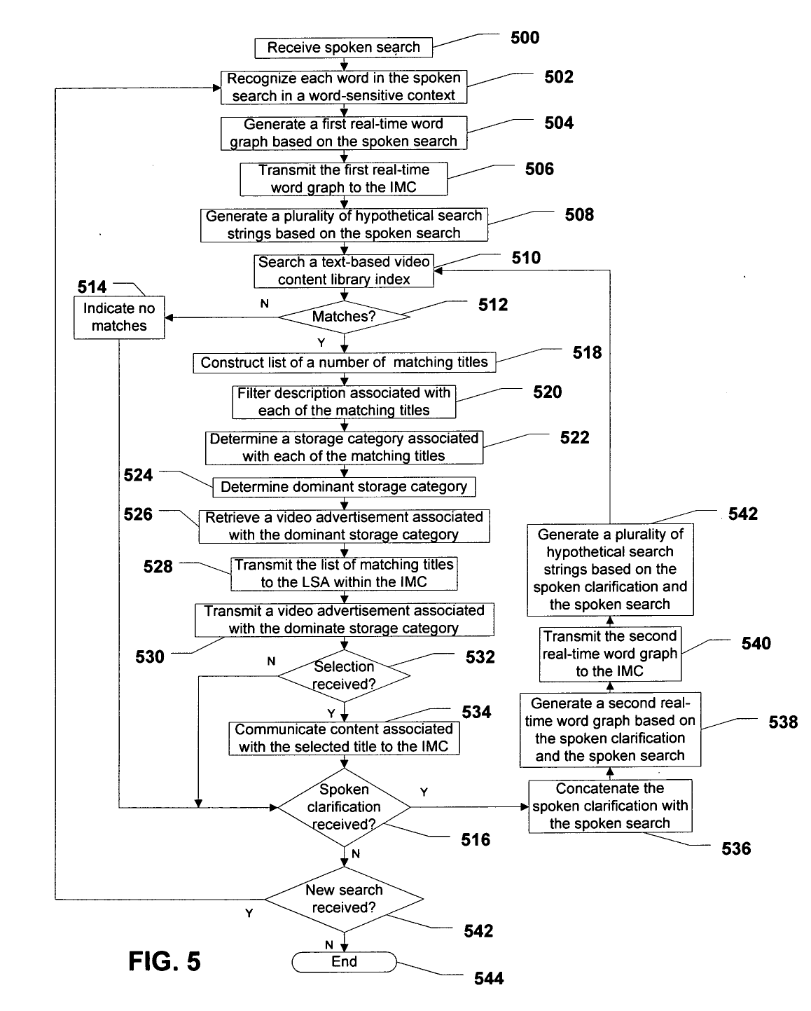

Referring to FIG. 5, a method of locating video content is shown and begins at block 500. At block 500, a server, e.g., the DSR network server shown in FIG. 1, receives a spoken search. At block 502, a dictation engine (DE) within the server recognizes each word in the spoken search in a word-sensitive context. Moving to block 504, the DE generates a first real-time word graph based on the spoken search. At block 506, the DSR network server transmits the first real-time word graph to an intelligent media center (IMC), e.g., the IMC shown in FIG. 1 and described above.

Proceeding to block 508, the DE within the DSR network server generates a plurality of hypothetical search strings based on the spoken search. Thereafter, at block 510, a video search engine (VSE) within the DSR network server searches a text-based video content library index using the hypothetical search strings generated by the DE. Continuing to decision step 512, the VSE determines whether any matches exist within the video content library index. If not, the method moves to block 514 and the DSR network server indicates to the IMC that no matches exist for the spoken search. The method then proceeds to decision step 516.

Returning to decision step 512, if one or more matches exist, the method proceeds to block 518 and the DSR network server constructs a list of a number of matching titles. At block 520, the DSR network server filters a description that is associated with each of the matching titles. In a particular embodiment, the DSR network server filters the description for each of the matching titles by searching each description with the hypothetical search strings generated by the DE. If a match is found within a particular description, the DSR network server will extract the matching term and at least two word that surround the matching term to create a partial description. The partial description can be included with the list of matching titles. Further, the list can include a rating for each title and a viewing duration for each title.

Continuing to block 522, the DSR network server determines a storage category that is associated with each of the matching titles. At block 524, the DSR network server determines a dominant storage category for the list of matching titles. In other words, the DSR network server determines which storage category is associated with more of the titles on the list of matching titles. Next, at block 526, the DSR network server, retrieves a video advertisement associated with the dominant storage category. In a particular embodiment, the video advertisement can be for an advertising customer that has bid the most for the right to advertise for the dominant category.

Moving to block 528, the DSR network server transmits the list of matching titles to the LSA within the IMC. At block 530, the DSR network server transmits the video advertisement associated with the dominant storage category to the IMC. Proceeding to block 532, the DSR network server determines whether a request for a selected title is received. If so, the DSR network server communicates the selected title to the IMC at block 534. If not, the method continues to decision step 516.

At decision step 516, the DSR network server determines whether a spoken clarification has been received. If a spoken clarification has been received, the method proceeds to block 536 and the DE within the DSR network server concatenates the spoken clarification with the previously received spoken search. Next, at block 538, the DSR network server generates a second real-time word graph based on the spoken clarification and the spoken search. At block 540, the DSR network server transmits the second real-time word graph to the IMC. Thereafter, at block 542, the DE within the DSR network server generates a plurality of hypothetical search strings based on the spoken clarification and the spoken search. The method then returns to block 510 and continues as described herein.

Moving to decision step 542, the DSR network server determines whether a new search is received. If so, the method returns to block 502 and continues as described herein. On the other hand, if a new search is not received, the method ends at state 544.

With the configuration of structure described above, the system and method of locating and providing video content within an IPTV network provides a way for users to transmit a spoken search and receive one or more results based on the spoken search. If the results do not satisfy the user, he or she can transmit a spoken clarification that can be concatenated with the spoken search and used to return new results. Since the need for a keyboard is obviated, the disclosed system and method makes locating video content within an IPTV network substantially easier for the user.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of obtaining video content, comprising:
receiving a spoken search;
determining each word in the spoken search in a word-sensitive context;
generating a first plurality of hypothetical search strings;
searching a text-based video content library index with the first plurality of hypothetical search strings;
determining whether any video content titles within the text-based video content library index match each of the first plurality of hypothetical search strings; and
transmitting a first plurality of matching video content titles to an intelligent media center.

2. The method of claim 1, further comprising indicating to the intelligent media center that no matching video content titles exist.

3. The method of claim 1, further comprising generating a word graph in real-time from the spoken search.

4. The method of claim 3, transmitting the word graph to the intelligent media center.

5. The method of claim 1, further comprising generating a list of matching video content titles corresponding to the first plurality of matching video content titles, wherein the list of matching video content titles includes each of the first plurality of matching video content titles, a rating of each of the first plurality of matching video content titles, a viewing duration of each of the first plurality of matching video content titles, and a summary description of each of the first plurality of matching video content titles.

6. The method of claim 5, wherein the summary description of each of the first plurality of matching video content titles includes at least one matching word from the spoken search and at least two words surrounding the matching word.

7. The method of claim 1, further comprising:
receiving a spoken clarification associated with the spoken search;
concatenating the spoken clarification with the spoken search;
generating a second plurality of hypothetical search strings based on the spoken search and the spoken clarification;
searching the text-based video content library index with the second plurality of hypothetical search strings;
determining whether any video content titles within the text-based video content library index match the second plurality of hypothetical search strings; and
transmitting a second plurality of matching video content titles to the intelligent media center.

8. The method of claim 1, further comprising:
determining a storage category for each of the first plurality of matching video content titles;
determining a dominant storage category for the first plurality of matching video content titles, wherein the dominant storage category is a storage category that is determined to be associated with most of the first plurality of matching video content titles; and
transmitting a video advertisement to the intelligent media center, wherein the video advertisement is associated with the dominant storage category.

9. The method of claim 8, wherein the video advertisement is further associated with an advertising customer that has submitted a highest advertising bid for the dominant storage category.

10. A method of obtaining video content, comprising:
receiving a spoken search from a wireless access terminal;
transmitting the spoken search to a server over a network;
receiving a plurality of matching video content titles from the server; and
comparing the plurality of matching video content titles to a locally stored search history.

11. The method of claim 10, further comprising selecting a plurality of most likely matching video content titles based on the locally stored search history.

12. The method of claim 11, further comprising creating a menu of most likely matching video content titles.

13. The method of claim 12, further comprising transmitting the menu of most likely matching video content titles to an Internet protocol television.

14. The method of claim 13, further comprising:
receiving a user selection of a selected title from the plurality of most likely matching video content titles; and
storing the selected title within the locally stored search history.

15. The method of claim 14, further comprising:
transmitting the selected title to the server;
receiving video content associated with the selected title; and
transmitting the video content to the Internet protocol television.

16. A system, comprising:
a video content library database storing a plurality of video content titles;
a video content library index including a text title associated with each of the plurality of video content titles stored within the video content library database and including a text description of each of the plurality of video content titles; and
a server coupled to the video content library database and coupled to the video content library index, the server comprising:
a processor;
a computer readable medium accessible to the processor; and
a computer program embedded within the computer readable medium, the computer program comprising:
instructions to receive a spoken search;
instructions to generate a first plurality of search strings from the spoken search; and
instructions to search the video content library index based on the first plurality of search strings to locate one or more matching video content titles.

17. The system of claim 16, wherein the computer program further comprises instructions to generate a first real-time word graph derived from the spoken search.

18. The system of claim 17, wherein the computer program further comprises instructions to transmit the real-time word graph to a remote device.

19. The system of claim 16, wherein the computer program further comprises:
instructions to receive a spoken clarification associated with the spoken search;
instructions to concatenate the spoken clarification and the spoken search;
instructions to generate a second plurality of search strings based on the spoken search and the spoken clarification; and
instructions to search the video content library index with the second plurality of search strings.

20. The system of claim 19, wherein the computer program further comprises instructions to generate a second real-time word graph based on the spoken search and the spoken clarification.

21. A portable electronic device comprising:
a microphone;
a talk button;
a processor;
a computer readable medium accessible to the processor; and
a computer program embedded within the computer readable medium, the computer program comprising:
a speech input agent; and
a distributed speech recognition front-end, wherein the speech input agent is activated in response to a selection of the talk button and wherein the speech input agent uses the distributed speech recognition front-end to record speech input received by the microphone in a high fidelity mode.

22. The device of claim 21, wherein the distributed speech recognition front-end extracts one or more acoustic features from recorded speech.

23. The device of claim 22, wherein the distributed speech recognition front-end extracts one or more phonetic features from recorded speech.

24. The device of claim 23, wherein the distributed speech recognition front-end compresses recorded speech.

25. The device of claim 24, wherein the distributed speech recognition front-end transmits compressed speech in real-time to a distributed speech recognition network.

26. The device of claim 25, wherein the compressed speech is transmitted via an intelligent media center.

27. The device of claim 26, wherein the device is a wireless access terminal having wireless fidelity capability.

28. The device of claim 26, wherein the device is a portable digital assistant having wireless fidelity capability.

29. The device of claim 26, wherein the device is a mobile telephone having wireless fidelity capability.

30. The device of claim 26, wherein the device is a remote control device having wireless fidelity capability.
